(19) United States
(12) Patent Application Publication
(10) Pub. No.: US 2016/0236126 A1
(43) Pub. Date: Aug. 18, 2016

(54) AIR PURIFICATION SYSTEM

(71) Applicants: Sui Chun LAW, Hong Kong (CN); Yiu Wai CHAN, Hong Kong (CN)

(72) Inventors: Sui Chun LAW, Shatin, New Territories (HK); Yiu Wai CHAN, Shatin, New Territories (HK)

(21) Appl. No.: 15/024,279

(22) PCT Filed: Sep. 23, 2014
(86) PCT No.: PCT/CN2014/087212

§ 371 Date: Mar. 24, 2016

(30) Foreign Application Priority Data
Sep. 24, 2013 (CN) 201320591570.3

(51) Int. Cl. B01D 46/00

(52) U.S. Cl. CPC B01D 46/0005

(57) ABSTRACT

An air purification system (800), comprising a first casing (801) and a second casing (802) mutually combined and forming the entirety or part of the housing of the air purification system (800); an air inlet (920) and an air outlet (910) are respectively disposed on the first casing (801) and the second casing (802); a filter (912) is received within the housing, and comprises a filter frame (9121) and filter element material (9122) provided inside the filter frame (9121); the air purification system (800) further comprises an air leak preventing sealing edge (913); a part of the air leak preventing sealing edge (913) is attached to one side (9123) of the filter frame (9121) facing toward the air inlet (920), and/or one side (9124) facing toward the inner side wall of the housing, and can withstand wind pressure coming from the air inlet (920) and pressing against the air leak proof sealing edge (913) against the filter frame (9121); and the other part of the air leak preventing sealing edge (913) is sandwiched in the junction of the first casing (801) and the second casing (802).

### BACKGROUND OF THE INVENTION

Pollutants in air exist in two major physical forms, one is the particulates matters with larger particles size, such as dust, bacteria or mildew. The particulate matters are formulated by the combination of different substances or components and have rather complicated chemistry structures. They have a size ranging from 0.01 to 1 microns meter in dimension. Another type of pollutant is chemical molecules, such as gas, odor, volatile organic compounds, etc, it has a simple chemical structure and has a small physical dimension in the ranges from 0.1 to 1 nanometers.

To treat any form of pollutants, the chemical and physical features of the pollutants will be concerned and different types of filtering materials or filters will be employed. Fan will be used to drive the air containing the pollutants to flow through the filtering materials or filters during purification.

In the case when the filtration method does not require the polluted air to reside within the filters or the filtering materials for a long time, generally speaking, the greater the airflow volume of the fan and the fast the airflow rate, the fast of decreasing of the concentration of pollutants. Therefore, an air purification system with a higher airflow volume will be more preferable when purifying a large volume of the polluted air. For example, in order to filter the air which contains the particulate matters such as PM2.5/PM10 pollutants, those air purification device or system which can provide higher airflow rate and airflow volume is preferable. According to the US AHAM standard, the Clean Air Delivery Rate (CADR) is higher for the air purification system having a higher airflow volume. These air purification systems can be employed for large area, or at the place where the pollutants levels are high, or a situation that a quick and effective purification is desired.

For the air Purification system with high airflow volume, the power consumption thereof is relatively increased. Nevertheless, the air purification efficiency of the air purification system may not be necessarily proportional to the respective energy consumption. In most case, for the conventional air purification equipment of system, when the air flow volume is increased to increase the amount of air purification, the system has not yet reached its limitation, and the performance often fails to meet expectations. For example, an amount of the purified air for the purification system at a lower air flow volume is about 5 units polluted air (the air which contains the pollutants) per joule. When airflow volume is doubled, and the energy consumption is also doubled, nevertheless, the amount of polluted air to be purified is 7 units per joule, rather than the expected 10 units per joule. The main reason for this is due to a gap existed between the filter and the casing of the air purification system. Generally, in order to enable the air purification system to easily replace the filter and to avoid size error between the new filter and the old one during the replacement, the existence of this gap is inevitable. However, this gap may also lead to the “leakage” of the air purification system.

FIG. 1a and FIG. 1b show the side views of a conventional air purification system. The conventional air purification system includes a casing 100, the fan 11 and a filter 12. Filter 12 is equipped at the upstream position (FIG. 1a) or the downstream position (FIG. 1b) of the fan 11. The housing 100 comprises an air inlet 200 and an air outlet 300.

The front side 400 of the filter 12 is defined as an area which the polluted air enters, the reverse side 500 is the side opposite to the front side 400 of the filter. The peripheral of the front side 400 (FIG. 1b) or the peripheral of the reverse side 500 (FIG. 1a) of the filter frame 12 is provided with sponge or gasket 13, clip(s) or clasp(s) 14 and/or the like, to buckle the filter 12 securely within the casing 100.

When the fan 11 is in operation, the air containing pollutants 501 will enter the air purification system 300 from the air inlet 501. It is then brought to the front side 400 of the filter 12 (FIG. 1a) or drawn to the front side 400 of the filter 12 from (FIG. 1b). An unavoidable gap 600 exists between the filter 12 and the casing 100 of the air purification system, and the air containing pollutants 501 may therefore bypass the filter 12 through the gap 600 and is discharged without purification, which results in such “air leakage”. Owing to the “air leakage”, certain power consumption of the fan 11 is wasted.

The adding of gasket seal or sponge 13, along with other components such as clips or clasp 14 and the like to buckle the filter 12 to the casing 100 will increase the complexity of manufacturing the air purification system, and the gap causing “air leakage” may not be completely eliminated. In addition, the intensity of clips 14 for buckling is hard to be fine-tuned during production. Too loose the buckling will not solve the “air leakage” problem. Too tight the buckling will cause the filter 12 to subject partial pressure. When the airflow volume is increased, the filter 12 may be deformed, thus wasting more energy due to the “air leakage” caused by the gap.

### SUMMARY OF THE INVENTION

To solve the above addressed problems, a particularly designed and cost-effective air purification system is provided herein, which can force the pollutants in the air to enter the filter for a completed purification, while the air purification effectiveness is maintained at least power consumption.

An air purification system includes: a first housing and a second housing, wherein a combination of the first housing and the second housing form a whole or partial of casing of the air purification system; said first and second housings are both provided with an air inlet and an air outlet, respectively; a filter is accommodated within the casing; the filter comprises a filter frame and a filter materials disposed within the filter frame; characterized in that the air purification system further comprises a sealing strap configured to prevent air leakage; one portion of sealing strap is attached to one side of the filter frame facing the air inlet and/or facing an inner sidewall of the casing; said portion of sealing strap is capable of withstanding an air pressure from the air inlet and is pressed against the filter frame by the air pressure; another portion of the sealing strap is sandwiched between the first and the second housings.

In one of the embodiments, the sealing strap is made of flexible material.

In one of the embodiments, the flexible material is polyethylene film.

In one of the embodiments, the system further includes a fan located at a side of the air inlet and configured to blow air toward the filter.

In one of the embodiments, the filter is accommodated within a storage space of the first housing.

In one of the embodiments, the filter is accommodated within a storage space of the second housing.

In one of the embodiments, one portion of filter is accommodated within a storage space inside the first housing and another portion of the filter is accommodated within a storage space inside the second housing.

In one of the embodiments, the first and second housings are provided with serration surfaces at a junction thereof engaging each other.

In one of the embodiments, the sealing strap and the filter frame are bonded together via adhesive.

In one of the embodiments, the sealing strap is bonded to the first housing and the second housing via adhesive.

In one of the embodiments, the adhesive is adhesive with low to medium level of adhesiveness.

In one of the embodiments, the system further includes a reinforcement component configured to reinforce the combination of the first housing and the second housing.

In one of the embodiments, the reinforcement component is located at an outer side of the casing.

When the airflow rate or airflow volume of the air purification system is increased, the positive air pressure exerts toward the filter will be increased. For the conventional air purification system, the increasing positive air pressure will increase the risk of air leakage, thereby causing the polluted air to bypass the filter. However, according to the embodiment of the air purification system, the positive air pressure will cause the sealing strap to be more firmly attached to the filter frame, thus further strengthening the effect of the sealing. The risk that the polluted air to be leaked and/or bypassing the filter before purification will not be increased due to the increase of the airflow volume. On the contrary, the polluted air to be prevented from “leaked” or bypassing the filter, thereby forcing the polluted air to pass through the filter, and a 100% effective filtration process is achieved. In addition, since the junction between the first and the second housings dose not withstand the airflow pressure, neither deformation nor air leakage problem will be occurred due to the increasing of the airflow volume.

The air purification system described above can be applied to any purification relating filtration, adsorption, or purification of chemical reaction. While helping to improve air quality, the filter material is 100% utilized. Furthermore, all the electrical power for driving the motor for the fan in the air purification system is ensured to be used for air purification, thus a maximum air purification efficiency is achieved.

The filter can be filinly attached to the air purification system without using soft glue, sponge, clips, or clasps, which are used by the manufacturers of the conventional air purification system. The filter cartilage materials of the filter will not subjected to localized pressure and will not be deformed. More importantly, when the airflow volume is increased, the sealing strap will play a more important role to prevent the air leakage by filinly attaching the filter, thus lowering the risk of air leakage. The present system can make sure the polluted air entirely passes through the filter, thus it is superior over the conventional system in which soft glue, sponge, clips, or clasps are used.

### BRIEF DESCRIPTION OF THE DRAWINGS

FIGS. 1a and 1b are schematic views of a conventional air purification system where a filter is installed inside the air purification system;

FIGS. 2 to 7 are schematic views illustrating a plurality of embodiments of the air purification system, where a sealing strap is employed to prevent the polluted air from being leaked and bypassing the filter;

FIG. 8 is a schematic view illustrating a wrong application of sealing strap, which causes the polluted air bypassing the filter; and

FIG. 9 is performance chart illustrating purification efficiency to particulate pollutant between the air purification system of the present invention and the air purification system of the same type before and after increasing of the airflow volume.

### DETAILED DESCRIPTION OF THE EMBODIMENTS

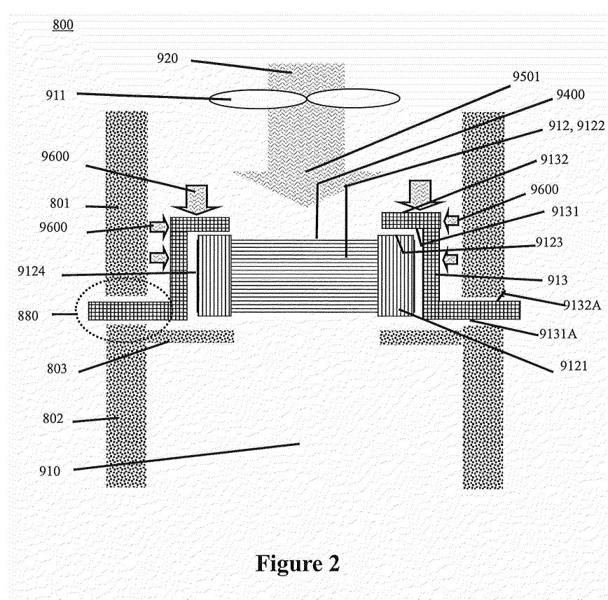

FIG. 2 illustrates a side view of one embodiment of an air purification system. The air purification system 800 includes a first housing 801 and second housing 802; a first housing 801 and second housing 802 may be combined to form a whole or a partial casing of the air purification system 800. An air inlet 910 and air outlet 920 are provided respectively at first housing 801 and second housing 802 of the air purification system 800.

The air purification system 800 further comprises a fan 911, a filter 912 and a sealing strap 913, which is used to prevent air leak. The first housing 801 or the second housing 802 is further provided with a supporting frame 803 to support the filter 912.

The filter 912 comprises a filter frame 9121 and a filter material 9122. The filter material 9122 is surrounded and protected by the filter frame 9121; the filter 912 is accommodated within the casing, which is formed by the combination of the first housing 801 and the second housing 802. The filter 912 is located at downstream of the fan 911. A front side 9400 of the filter 912 is defined as a side facing the polluted air 9501. When the fan 911 is turned on, the air 9510 which containing pollutants will enter the air purification system 800 from the air inlet 920 and blow into the front side 9501 of the filter 912.

The sealing strap 913 is a long flat strip with a certain thickness or an annular sealing strip. When the filter frame 9121 is in a quadrilateral shape, the sealing strap 913 can be an elongated shape, which is constituted by at least four sealing strap 913 connecting together to completely surround and attach the quadrilateral filter frame 9121. The connection points of the sealing straps are located at four corners of the filter frame 9121, and the sealing straps overlaps with each other at the four corners of the filter frame 9121, so as to prevent the polluted air from bypassing the filter 912. When the filter frame 9121 is in a circular shape, the sealing strap 913 will be in a corresponding circular shape.

A portion of the sealing strap 913 is attached to a side of the filter frame 9121 facing to the air inlet, which is the forward side 9131 of the filter frame 9121 and a peripheral side face 9124 of the filter frame 9121 facing an inner side of the casing. One side of the sealing strap 913 attached to the front side 9123 of the filter frame 9121 is referred as a forward side 9131 of the sealing strap 913, while the other side of the sealing strap 913 opposite to the forward side 9131 is referred as a rear side 9132. The forward side 9131 of the sealing strap is provided with some adhesive, by which the sealing strap 913 can be attached the filter frame 9121 of the filter 912. The adhesive is adhesive with low to medium level of adhesiveness, such that the repeat attaching and detaching of the sealing strap 913 from the filter frame 9121 will not leave any residues on the filter frame 9121.

Another portion of the sealing strap 913 is sandwiched between the first housing 801 and second housing 802, thus forming a “sandwich” structure 880. In the sandwich structure, one side of the sealing strap 913 facing the second housing 802 is defined as the forward side 9131A, and the other side of the sealing strap facing the first housing 801 is defined as the rear side 9132A.

The forward side 9131A and rear side 9132A of the sealing strap 913 are provided with adhesive with low to medium level of adhesiveness; when the “sandwich” structure 880 is detached, there will be not residues left on the first housing 801 and the second housing 802.

When the air purification system 800 is started, the air 9501 blows toward the front side 9400 of filter 912. The air pressure 9600 generated by the air flow is exerted onto the rear side of 9132 of the sealing strap 913, such that the sealing strap 913 attached to the front side 9123 of the filter frame 9121 is more firmly pressed against the front side 9123 of the filter frame 9121. On another hand, by the configuration of the “sandwich” structure 880, the bypassing of the polluted air 9501 through the peripheral of the filter 912 can therefore be completely avoided.

In the embodiment as shown in FIG. 2, the filter 912 is accommodated within a storage space of the first housing 801. In this case, the sealing strap 913 is attached to the front side 9123 and/or the side face 9124 of the filter frame 9121. The sealing strap 913 is in the form of Z shape.

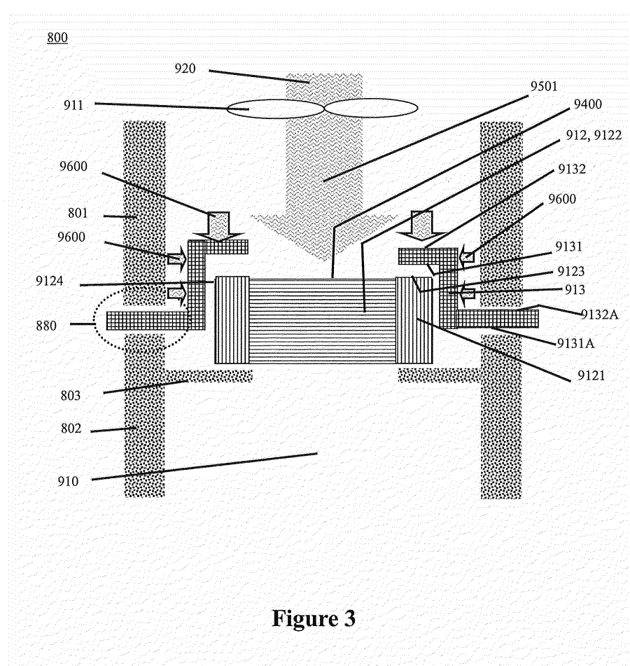

In the embodiment as shown in FIG. 3, one portion of the filter 912 is accommodated within the storage space of the first housing 801 and another portion of the filter 912 is accommodated within the storage space of the second housing 802. In this case, the sealing strap 913 is attached to the front side 9123 and/or the side face 9124 of the filter frame 9121. The sealing strap 913 is in the form of Z shape.

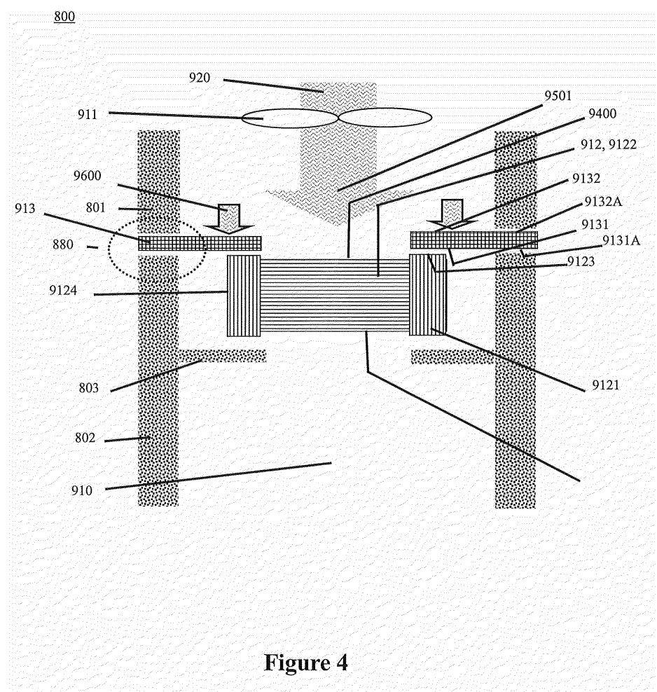

In the embodiment as shown in FIG. 4, the filter 912 is accommodated within the storage space of the second housing 802. In this case, the sealing strap 913 is attached to the front side 9123 of filter frame 9121. The sealing strap 913 is in the form of “-” shape.

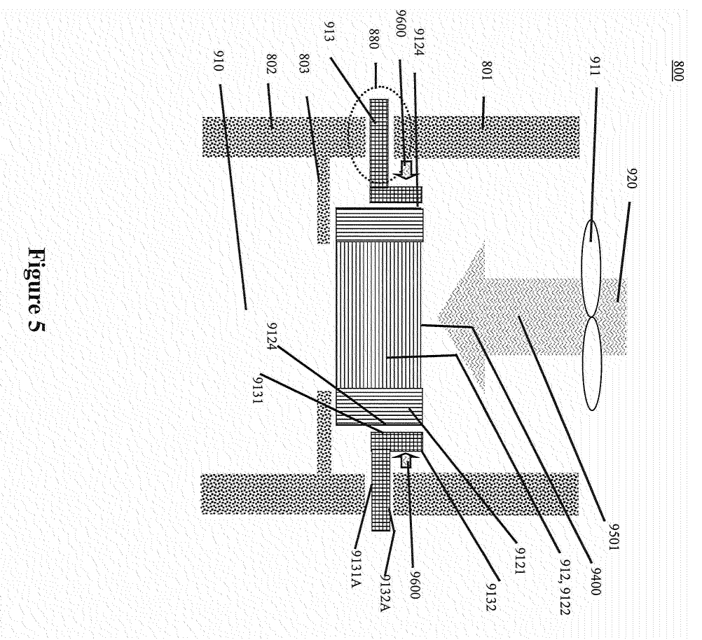

In the embodiment shown in FIG. 5, one portion of the filter 912 is accommodated within the storage space of the first housing 801 and another portion of the filter 912 is accommodated within the storage space of the second housing 802. In this case, the sealing strap 913 is attached to the side face 9124 of the filter frame 9121. The sealing strap 913 is in the form of L shape.

No matter which position the filter 912 is placed in the casing, the rear side 9132 of the sealing strap 913 must be the side to withstand the air pressure.

In the above described embodiment, the first housing 801 and the second housing 802 can be regarded as a front housing and a rear housing, or an upper housing and a lower housing, depend on the installation method of the filter 912.

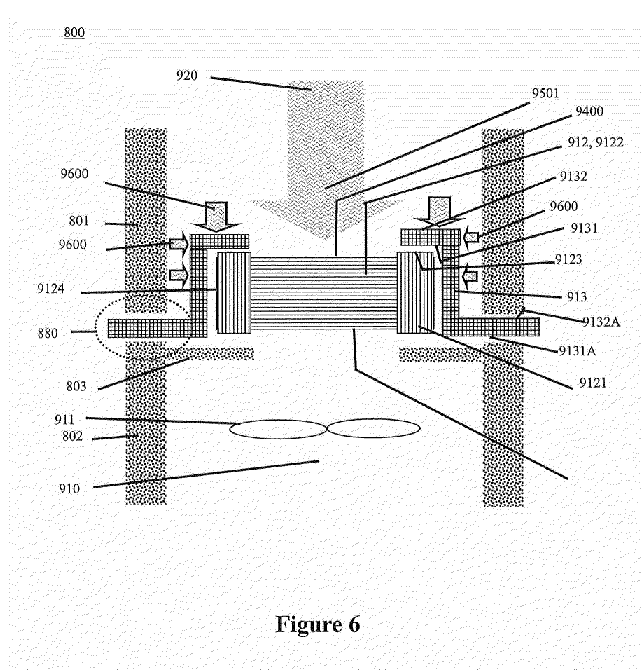

Referring to FIG. 6, based on the embodiments as described previously, the fan 911 is located within the storage space of the second housing 802, i.e. at a downstream position of the filter 912.

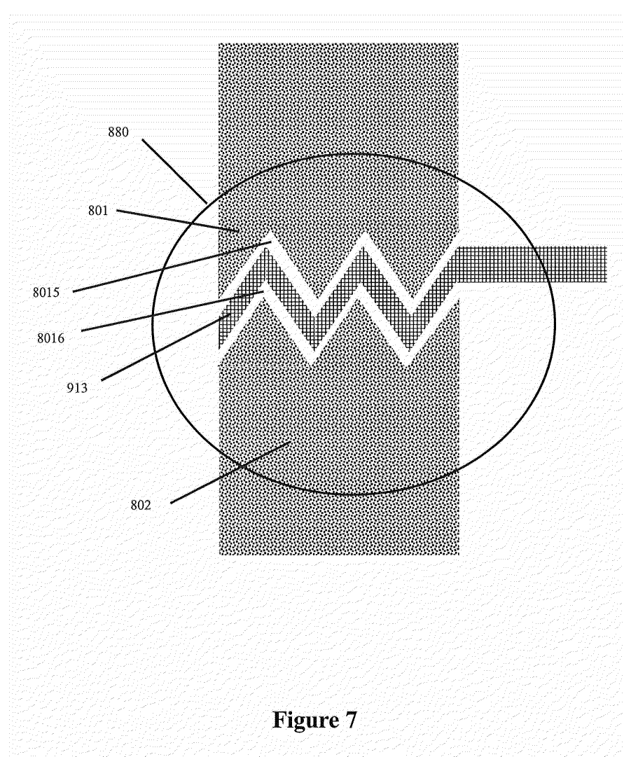

Referring further to FIG. 7, in all of the above-described embodiments, the first housing 801 and the second housing 802 are provided with serration surfaces at a junction thereof engaging each other. A recessed surface 8015 of the serration surfaces of the first housing 801 is corresponding to a protruded surface 8016 of the serration surfaces of the second housing 802. The sealing strap 913 is made of flexible material, such as polyethylene film, etc., such that it can be clamped between the first housing 801 and the second housing 802.

It should be understood that, in order to enhance sealing, other engaging manner similar to the serrations can be employed. In addition, other components such as the outer clip and clasps can be employed to further reinforce the combination of the first housing 801 and the second housing 802.

When the airflow rate or airflow volume of the air purification system is increased, the positive air pressure exerts toward the filter will be increased. For the conventional air purification system, the increasing positive air pressure will increase the risk of air leakage, thereby causing the polluted air to bypass the filter. However, according to the embodiment of the air purification system, the positive air pressure will cause the sealing strap to be more firmly attached to the filter frame, thus further strengthening the effect of the sealing. The risk that the polluted air to be leaked and/or bypassing the filter before purification will not be increased due to the increase of the airflow volume. On the contrary, the polluted air to be prevented from “leaked” or bypassing the filter, thereby forcing the polluted air to pass through the filter, and a 100% effective filtration process is achieved. In addition, since the junction between the first and the second housings dose not withstand the airflow pressure, neither deformation nor air leakage problem will be occurred due to the increasing of the airflow volume.

The air purification system described above can be applied to any purification relating filtration, adsorption, or purification of chemical reaction. While helping to improve air quality, the filter material is 100% utilized. Furthermore, all the electrical power for driving the motor for the fan in the air purification system is ensured to be used for air purification, thus a maximum air purification efficiency is achieved.

The filter can be filinly attached to the air purification system without using soft glue, sponge, clips, or clasps, which are used by the manufacturers of the conventional air purification system. The filter cartilage materials of the filter will not subjected to localized pressure and will not be deformed. More importantly, when the airflow volume is increased, the sealing strap will play a more important role to prevent the air leakage by firmly attaching the filter, thus lowering the risk of air leakage. The present system can make sure the polluted air entirely passes through the filter, thus it is superior over the conventional system in which soft glue, sponge, clips, or clasps are used.

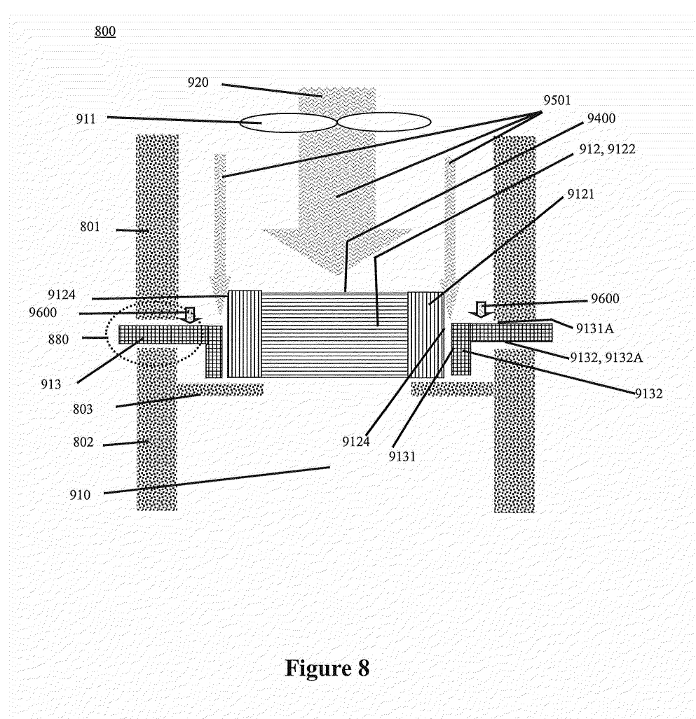

It should be noted that, referring to FIG. 8, when the forward side 9131, 9131A of the sealing strap 913 (i.e. the side of the sealing strap attached the filter frame 9121) is to withstand the air pressure generated directly by the operation of fan 911 of the air purification system (i.e. one side of the forward side of the sealing strap 913 facing the polluted air 9501), it cannot help to filinly attach the sealing strap 913 to the filter frame 9121. This feature is not included in any embodiment of this invention. And this will not help to prevent polluted air 9501 from bypassing the front side of the filter or leakage through the peripheral position. If the air pressure is increased, instead of having the sealing strap attached thinly to the filter, a gap can easily be created, which will increase the risk of air leakage, and the polluted air will bypass the filter.

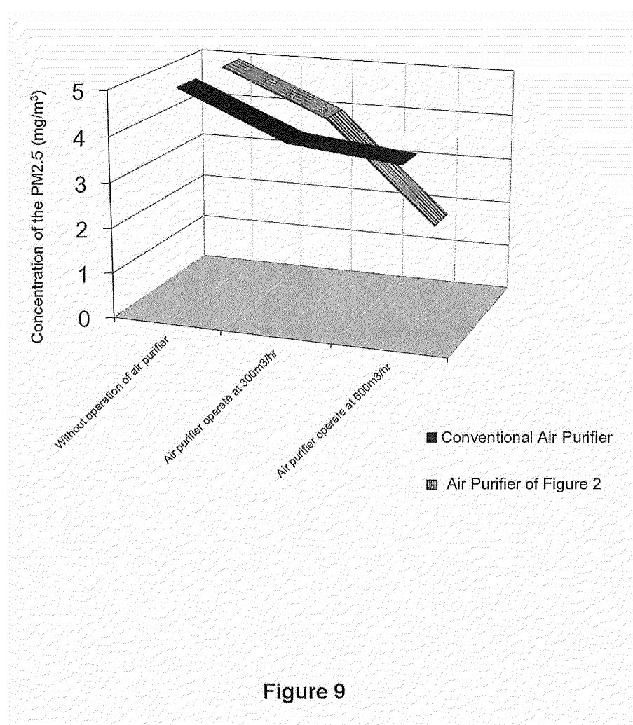

FIG. 9 is performance chart illustrating a purification efficiency to particulate pollutant between the air purification system of the present invention and the air purification system of the same type before and after increasing of the airflow volume. In a room having a floor area of 100 m²×4 meters height, a lighted cigarette is used to create an environment with a fine particulate matter (PM2.5) reach to a level of 5mg/m³ (milligram per cubic meter).

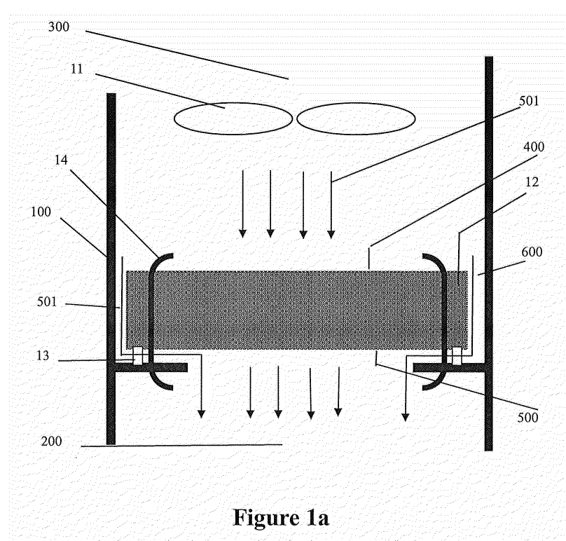

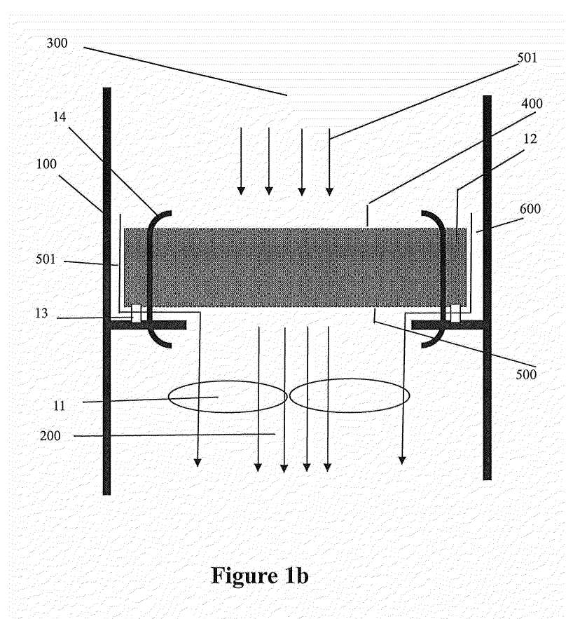

If the air purification system as shown in FIG. 1a (or FIG. 1b) is used, at an air flow rate of 300 m³/hr (cubic meters/hour), the PM2.5 level can be reduced from 5 mg/m³ to 4 mg/m³ within 10 minutes (i.e. the filter is able to reduce the PM2.5 by 1 mg/m³ in 10 minutes); however, when the airflow rate is doubled to 600 m³/hr, it can only reduce the PM2.5 from 5 mg/m³ to 3.75 mg/m³ within 10 minutes, instead of 3 mg/m³.

If the air purification system as shown in FIG. 2 is employed, when the air flow rate reaches 600 m³/hr, the level of PM2.5 can be reduced from 5 mg/m³ to 1.8 mg/m³ within 10 minutes, which exceeds the expected 3 mg/m³. According to the method employed in the present invention, the greater the air flow volume, the better performance of the sealing strap to be attached to the filter, thus preventing the “air leakage”, and 100% of the polluted air is completely forced to pass through the filter.

A fluid pumping system is provided, which includes a first housing and a second housing, wherein a combination of the first housing and the second housing form a whole or partial of casing of the fluid pumping system; the said first and second housings are both provided with a fluid inlet and a fluid outlet, respectively; a main function element is housed within the casing; the main function element comprises a frame; characterized in that the fluid pumping system further comprises a sealing strap configured to prevent leakage; one portion of sealing strap is attached to one side of the frame facing the fluid inlet and/or facing an inner sidewall of the casing; said portion of sealing strap is capable of withstanding an fluid pressure from the fluid inlet and is pressed against the frame by the fluid pressure; another portion of the sealing strap is sandwiched between the first and the second housings.

The fluid pumping system can be water treatment systems, kitchen ventilation systems, etc, or other system where an enhanced performance by prevent leakage is desired. The main function element can be operated along with the sealing strap of the present invention, thus a maximum performance of the operation can be achieved.

Although the invention is illustrated and described herein with reference to specific embodiments, the invention is not intended to be limited to the details shown. Rather, various modifications may be made in the details within the scope and range of equivalents of the claims and without departing from the invention.

1. An air purification system, comprising: a first housing and a second housing, wherein a combination of the first housing and the second housing form a whole or partial of casing of the air purification system; said first and second housings are both provided with an air inlet and an air outlet, respectively; a filter is accommodated within the casing; the filter comprises a filter frame and a filter materials disposed within the filter frame; characterized in that the air purification system further comprises a sealing strap configured to prevent air leakage; one portion of sealing strap is attached to one side of the filter frame facing the air inlet and/or facing an inner sidewall of the casing; said portion of sealing strap is capable of withstanding an air pressure from the air inlet and is pressed against the filter frame by the air pressure; another portion of the sealing strap is sandwiched between the first and the second housings.

2. The air purification system according to claim 1, wherein the sealing strap is made of flexible material.

3. The air purification system according to claim 2, wherein the flexible material is polyethylene film.

4. The air purification system according to claim 1, further comprising a fan located at a side of the air inlet and configured to blow air toward the filter.

5. The air purification system according to claim 1, further comprising a fan located at a side the air outlet and configured to draw air from the filter.

6. The air purification system according to claim 1, wherein the filter is accommodated within a storage space of the first housing.

7. The air purification system according to claim 1, wherein the filter is accommodated within a storage space of the second housing.

8. The air purification system according to claim 1, wherein one portion of filter is accommodated within a storage space inside the first housing and another portion of the filter is accommodated within a storage space inside the second housing.

9. The air purification system according to claim 1, wherein the first and second housings are provided with serration surfaces at a junction thereof engaging each other.

10. The air purification system according to claim 1, wherein the sealing strap and the filter frame are bonded together via adhesive.

11. The air purification system according to claim 1, wherein the sealing strap is bonded to the first housing and the second housing via adhesive.

12. The air purification system according to claim 10, wherein the adhesive is adhesive with low to medium level of adhesiveness.

13. The air purification system according to claim 1, further comprising a reinforcement component configured to reinforce the combination of the first housing and the second housing.

14. The air purification system according to claim 13, wherein the reinforcement component is located at an outer side of the casing.

15. A fluid pumping system, comprising: a first housing and a second housing, wherein a combination of the first housing and the second housing form a whole or partial of casing of the fluid pumping system; the said first and second housings are both provided with a fluid inlet and a fluid outlet, respectively; a main function element is housed within the casing; the main function element comprises a frame; characterized in that the fluid pumping system further comprises a sealing strap configured to prevent leakage; one portion of sealing strap is attached to one side of the frame facing the fluid inlet and/or facing an inner sidewall of the casing; said portion of sealing strap is capable of withstanding an fluid pressure from the fluid inlet and is pressed against the frame by the fluid pressure; another portion of the sealing strap is sandwiched between the first and the second housings.

16. The air purification system according to claim 11, wherein the adhesive is adhesive with low to medium level of adhesiveness.
